(19) United States
(12) Patent Application Publication
(10) Pub. No.: US 2003/0215780 A1
(43) Pub. Date: Nov. 20, 2003

(54) Wireless audience polling and response system and method therefor

(75) Inventors: David A. Saar, Titusville, NJ (US); Eli F. Bleich, South Norwalk, CT (US)

Correspondence Address: SUGHRUE MION, PLLC, 2100 PENNSYLVANIA AVENUE, N.W., WASHINGTON, DC, 20037, US

(73) Assignee: MEDIA GROUP WIRELESS

(21) Appl. No.: 10/145,890

(22) Filed: May 16, 2002

(51) Int. Cl. G09B 3/00

(52) U.S. Cl. 434/351; 725/24

(57) ABSTRACT

A wireless audience response system that comprises a plurality of remote response units, each of the response units comprising a first transmitter, a first receiver and a first processor coupled to the first transmitter and the first receiver and having a selectable input, the input being operable by a user to instruct the first processor to provide a response output, comprising at least one of a plurality of outputs, to the first transmitter. There also is a central control unit comprising a second transmitter, a second receiver and a second processor operatively coupled to the second transmitter and the second receiver. The second processor is operative to control the second transmitter to selectively transmit a command signal, comprising at least one of a plurality of command signals, to said plurality of remote response units, and dynamically assign a plurality of time slots to respective ones of the remote response units. The first transmitter at each of the remote response units is in communication with the second receiver at the central control unit over an assigned channel, the assigned channel being operative to carry information input by audience members and transmitted by a plurality of the remote response units in the respective dynamically assigned time slots to the central unit.

### BACKGROUND OF THE INVENTION

1. Technical Field

The present invention relates to an audience polling and response system and method therefor, and in particular to a method and apparatus in which remote handheld units that are operated by audience members to record a response to a particular issue or question, may be in communication with a central control unit in order to systematically collect the response from all participating members of the audience. The invention is particularly applicable to an environment where a facilitator, group leader or teacher solicits responses from participants in a seminar, students in a classroom or members of another group that are being led and polled, in order to provide responses to framed questions or issues.

2. Related Art

An audience response system that is designed to satisfy the foregoing need may be hardwired. In such case, an operator at a central control unit will transmit requests for information from, or input to, remote units that are connected via wires, either direct dedicated lines connections or via a switched system to which multiple remote units are hardwired to a switching system that connects to the central unit. Web-based survey systems using the Internet are one example of this type of “wired” system, even though some portions of applicable communication links may be via satellite or wireless transmission within the network. The alternative type is the pure wireless communication system, which is better adapted to a confined environment, such as a lecture hall meeting room or conference area, where the participants are assembled in a common location to obtain information, view live or video presentations and provide their input to questions or issues raised by a meeting or conference facilitator.

For such arrangements, low cost and highly efficient localized systems are required. Furthermore, because such meetings often are held in a common or generic area, the equipment must be transportable and easily handled by the audience participants. Desk-type stations are inconvenient for such purposes, while small, hand-held units or easily portable units are preferred.

Given such environment, it is desirable to have questions or issues posed by the facilitator one at a time, to have a record of such question recorded in a processor-based system and to have the response of the audience participants, individually or as a group, recorded in a database for subsequent analysis. A system must be highly responsive and efficient, given the need for a “natural” seminar or conference environment in which questions posed are immediately followed by answers and, a follow-up question is presented shortly afterwards for further response. Furthermore, there is a need for a system that can accommodate large groups of people, as in a large university classroom or association conference or meeting. The system must be capable of establishing a query and accumulating the response thereto from all participants within a short time and with high accuracy, prior to transmitting a subsequent query. Further, there must be the ability to ensure that each query is received and the response accurately accumulated for analysis and review. In order to reduce costs, the system should not be complex, yet must have a demonstrated accuracy and reliability.

One conventional wireless polling and response system is disclosed in U.S. Pat. No. 5,093,786 in which a central control unit and a plurality of remotely located response units having appropriate input devices are provided to individual users. A central control unit sequentially transmits distinct address words that are uniquely assigned to individual remote response units. A response unit, upon reception of its unique address word from the central unit, will transmit any accumulated data, as bytes corresponding to a user's selection of keys or buttons on the response unit, as an answer to a pending question. The central control unit checks the validity of the received transmission and then transmits an acknowledge bit, which is operative when received by the response unit that sent the answer, to cause the unit to get ready for the next query or even power down. Each response unit transmits its data bytes simultaneously, with the central control unit transmitting the address word for the next timing unit that is to respond with the transmissions occurring over distinct frequency channels. A feature of this system is that the transmitter must transmit a plurality of requests, each to different addresses, in order to obtain the response to a large number of remote units. There is a need for an alternative design, a system and method that permits a single query or polling of a large number of response units from a central unit in an audience participation system. There also is a need for a convenient participant registration method that can permit individual or an entire assembly of response units to be registered on command.

### SUMMARY OF THE INVENTION

According to a first feature of the present invention, a wireless audience response system is provided comprising a plurality of remote response units and a central communication unit. Each of the remote response units comprises a first transmitter, a first receiver and a first processor coupled to the first transmitter and the first receiver. Each remote response unit has a selectable input, the input being operable by a user to command the first processor to provide at least one of a plurality of outputs to the first transmitter. The central communication unit comprises a second transmitter, a second receiver and a second processor coupled to the second transmitter and the second receiver. The second processor is operative to control the second transmitter to output command signals and to dynamically assign a plurality of time slots to the remote response units. The first transmitter and first receiver at each of the remote response units is in communication with the second receiver and second transmitter at the central communication unit over an assigned channel. The assigned channel is operative to carry information input by audience members and transmitted by a plurality of the remote response units in the respective dynamically assigned time slots to the central control unit.

Another feature of the present invention is a central control unit, operative in a wireless audience response system having a plurality of remote response units, the central control unit being in communication with each of the remote response units over a communications link comprising an assigned channel. The assigned channel is operative to carry information transmitted by each of the plurality of remote response units in a respective one of a plurality of dynamically assigned time slots. The central control unit comprises a transmitter, a receiver and a processor coupled to the transmitter and receiver. The central control unit is operative to:

(a) transmit command signals to the plurality of remote response units on the assigned channel and to receive reply signals from at least one of the remote units in response thereto;

(b) register a plurality of the remote response units and dynamically assign one time slot in the assigned channel to each of the plural remote response units;

(c) transmit at least the assigned time slot and assigned channel information to the remote response unit;

(d) receive a response from each of the plurality of remote response units in respective time slots on the assigned channel; and

(e) correlate and store a response for each remote response unit with a unique identifier for each remote response unit.

Another feature of the present invention is a method of operating a wireless audience response system having a plurality of remote response units, each of the response units comprising a first transmitter, a first receiver and a first processor coupled to the first transmitter and the first receiver and having a selectable user input. The user input is operable by a user to command the first processor to provide at least one of a plurality of outputs to the first transmitter. There also is a central communication unit comprising a second transmitter, a second receiver and a second processor coupled to the second transmitter and the second receiver, the second processor being operative control the second transmitter to output a command signals, including voting command signals. The method comprises an operation wherein second transmitter transmits command signals over the assigned channel, the remote response units receive the transmitted command signals and, in response to receipt of at least one of the command signals, the remote response units delay the transmission of a respective selected output to the second receiver in a respective assigned time slot of a response frame over the assigned channel. The central receives and stores the respective selected outputs transmitted from the plurality of remote response units in respective assigned time slots.

A further feature of the present invention is a remote response unit, operative in a wireless audience response system having a plurality of such remote response units in communication with a central communication unit over an assigned channel, the assigned channel being operative to carry information transmitted by each of the remote response units in a respective one of a plurality of dynamically assigned time slots within a response frame. The remote response unit comprises a transmitter, a receiver and a processor coupled to the transmitter and receiver. The remote response unit being operative to:

(a) respond to a command for registration from the central communication by transmitting a unique ID to the central communication unit;

(b) receive an assignment by the central control unit of at least one time slot in at least one channel; and

(c) transmit information to the central communication unit in accordance with the assigned time slot and channel.

### BRIEF DESCRIPTION OF THE DRAWINGS

FIG. 1A is a schematic diagram of a remote response system according to an exemplary embodiment of the present invention, including a central communication control unit and multiple remote response units.

FIG. 1B is a representative illustration of the allocation of the communication medium in the system according to the invention, which includes multiple communication channels, including a common channel and multiple assigned channels, there being multiple time slots on each assigned channel.

FIG. 2 is an illustration of a schematic diagram of an exemplary remote response unit, in accordance with the present invention.

FIG. 3 is an illustration of a schematic diagram of an exemplary central control unit, in accordance with the present invention.

FIGS. 4A-4G are illustrations of various signals, which exist during a registration and other unit response operations of an exemplary system in accordance with the present invention.

FIG. 5 is an illustration of the content of an exemplary data transmission in accordance with the present invention.

FIG. 6A illustrates signals from the remote response units and appearing during a registration process, in accordance with an embodiment of the present invention.

FIGS. 6B and 6C illustrate signals from the central communication control unit and appearing during a registration process, in accordance with an embodiment of the present invention.

FIG. 7A is an illustration of an exemplary manual registration process for a remote unit, conducted at the central control unit.

FIG. 7B is an illustration of an exemplary auto registration process as conducted at the central control unit.

FIG. 8A is a flowchart illustrating the operation of a remote response unit when responding to a registration request by a central communication unit.

FIG. 8B is a flowchart illustrating the operation of a remote response unit when polled by a central communication unit.

FIG. 9 is an illustration of a remote response unit in the form of a hand held device.

### DESCRIPTION OF THE PREFERRED EMBODIMENTS

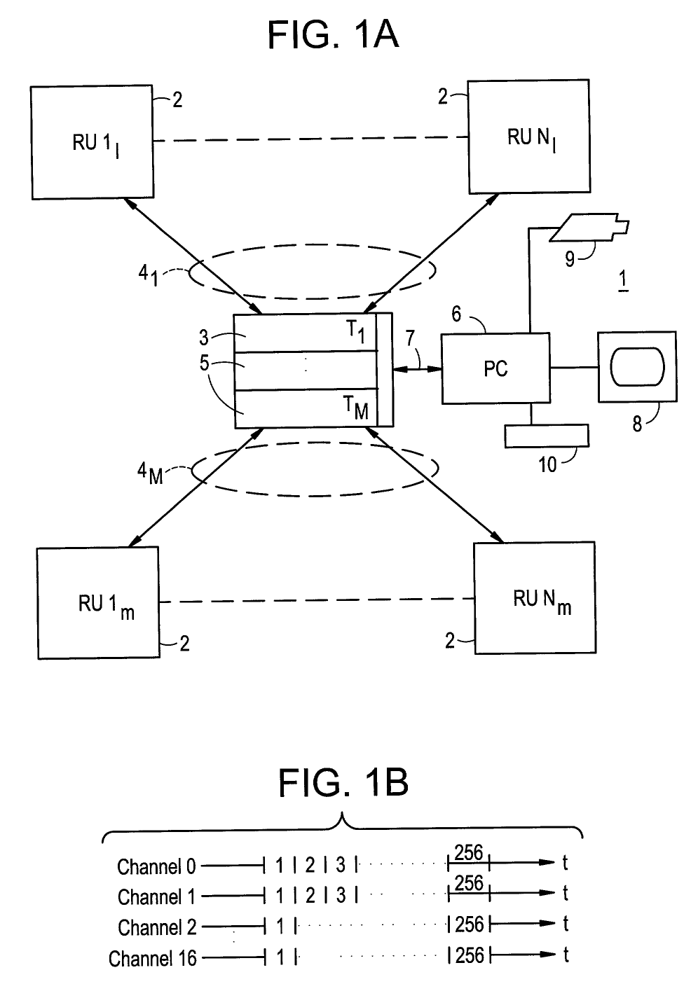

Referring specifically to the figures, and the exemplary embodiments of the invention that are depicted therein, FIG. 1A illustrates a schematic of a wireless audience response system 1 having a central communication unit 3 that is in communication with several remote response units 2 via wireless communication links 4 that are established by one or more transceiver cards 5. In the exemplary embodiment disclosed herein, the central communication unit 3 is connected to a personal computer (PC) or other processor 6 (for example, but not limited to a PDA of sufficient capacity; or optionally eliminated in favor of a processor built into the central communication unit or its transceiver cards) via a direct link 7, which for the illustrated embodiment may be a serial over USB link established via a USB converter that is connected to the RS232 port of the unit 3, but alternatively may be a direct wired link that meets the RS232 or RS485 standards. The connection 7 between the central communications unit 3 and the PC 6 alternatively may be via a wireless infrared (IR) broadband link, or other wireless-type link, as is known in the art. The connection of multiple transceivers via their individual serial ports to PC 6 may be implemented using hubs, in a manner known in the art. The central communications unit 3 and PC 6 together constitute a central control unit that manages the entire system during an audience response session.

Each transceiver card 5 in the central communications unit 3 has a transceiver T_{M}, where M may be 1-17, and in one exemplary embodiment M would be 2, with only two transceiver cards 5 being mounted in a single communications unit enclosure. In an embodiment where M=17, a group of up to seventeen channels 4 may be assigned for communication between the central communications unit 3 and the remote response units 2, with a single channel 4 being allocated to each transceiver card 5. Each transceiver T_{M} on a card 5 is operative to communicate (transmit and receive) over its assigned channel 4 with a corresponding group of remote units RU1_{M}-RUN_{M} where “N” is a number up to 256. As illustrated in FIG. 1A, each remote unit 2 (RU1-RUN) that is in communication with an assigned transceiver T_{M} over a single assigned channel 4 will have appropriate transmission and reception equipment, preferably in the form of a transceiver that can be tuned to any of the plurality of communication channels 4. In an exemplary embodiment where M=2, each of the two transceivers T_{M} in central communications unit 3 can be tuned to communicate over any of the 17 available data channels 4, but will be assigned by PC 6 during a given audience participation session to use only specific, typically one or more (in this case 2) channels, for communication.

An assigned channel 4 can be used to broadcast commands from a transceiver T_{M} to its assigned group of remote response units 2, and to carry responses to the commands from the units 2 to the transceiver T_{M}. One command carried by the channel 4 is a “null” command that may be used by the remote response units 2 to update their clocks, and other commands will control the registration, voting and other processes of the remote response units 2. When the remote response units 2 are required to respond to commands, as in a voting operation, the assigned channel 4 can be time divided according to the number N of remote units 2 that are in communication with the corresponding transceiver T_{M} at the central communications unit 3 at any given time. In the exemplary embodiment, each of the channels may be divided into a PC-determined number of time slots, up to 256 timeslots, as illustrated in FIG. 1B. In accordance with an exemplary embodiment, up to 4 sets of 256 slots may be used to support approximately 1000 remote response units per transceiver. Optionally, each set may contain a predetermined group of channels and each set may be identified by a predetermined number or code, for purposes of selection and control.

In an exemplary audience participation session, a sequence of questions, situations or issues may be delivered visually or orally by a conference facilitator, each requiring a response by the participants. The audience response to an individual question or the like will be solicited during a “voting period,” that typically has a finite duration. Where there are a series of questions, a series of voting periods will be required. The conference facilitator will operate the system in a manner subsequently described so that all participants will have an opportunity to respond in a timely manner to each question, so that their responses will be accumulated, properly correlated and stored, and the results presented as desired.

In order to be able to poll all participating remote response units 2 during an audience participation session, a voting operation, using the illustrated wireless audience response system 1 in FIG. 1A, will require the transceiver T_{M} in the central communication unit 3 to obtain 11 transmitted bytes from a remote response unit 2, including 5 bytes of data, from up to 256 response units 2 within a five second response period using a single one of the channels 4. As already noted, a larger number of response units 2 can be accommodated by a single central communication unit 3, by using multiple transceiver cards 5 to communicate over multiple data channels 4, each divided into up to 256 time slots. In an exemplary embodiment, the 915 MHz radio band under FCC, Section 15.249 narrowband rules is used because it offers the desired performance at low cost. This system results in a data rate of about 10,000 baud with a 4-byte equivalent header, and the transmission of one data packet from one of the remote units 2 to the central communication unit 3 will take about 14 milliseconds. In the exemplary embodiment, the transmission from each response unit 2 consists of a 3 byte unique serial number, 5 bytes of data (which supports entry of 10 characters), a time stamp byte and a 2-byte checksum. This will allow 6 milliseconds of time for a guard band and acknowledgement, and still support communication from approximately 50 remote response units per second. In an exemplary embodiment, a maximum of 256 remote response units may be polled within a five-to six-second period. Given the foregoing frequency allocation, a target range for the exemplary embodiment is 200 feet from the central communications unit 3 to the remote response units 2. In order to achieve this range, effective interference levels in the area of the conference as well as central communication station antenna location and shielding of the remote response unit 2 by the user must be considered, in a manner known in the art.

The process of accumulating votes that are cast by users operating remote response units 2 in answer to a pending question or issue, is initiated by the transmission from the transceiver T_{M} in central communication unit 3 of a voting command signal on an assigned channel 4. The first voting command signal from the transceiver T_{M} will open a transceiver “voting period,” and the voting period will remain open until the PC commands the transceiver T_{M} to close the voting period. The transceiver T_{M} will continue to issue the voting command periodically during the voting period, approximately every 1.3 seconds, in order to ensure that the command can be detected and to enable the command to serve as a synchronization signal for the remote unit 2 (notably, in an exemplary embodiment, a time slot may be 1.3 sec. or a multiple thereof in duration). As subsequently explained in detail, the command from the central control unit 3 that is sent via the transceiver T_{M} also will be accompanied by an interval count signal that indicates the number of 1.3 second intervals that have occurred since the response period was first opened.

A remote response unit 2, upon first receiving a voting command signal (which may not be the first signal transmitted from transceiver T_{M}, but a subsequent voting command signal, due to interference or the like), will perform several acts. First, the remote response unit 2 will open a response period for that unit, during which a single key or multiple key input from a user may be obtained. Second, the remote response unit 2 will also receive and store the interval count signal that is transmitted with each voting command signal. Third, the remote response unit 2 will process the command signal for starting an accumulation of time markers that are generated in tenths of a second. Each remote response unit 2 will continue to receive the periodically transmitted voting command signals from its corresponding transceiver T_{M} and continue to accumulate the time markers, but will not store subsequently received interval count signals. The remote response unit 2 will not respond to the voting command until a user has input a single or multi key response, as appropriate. Once the user input to a remote unit 2 has been completed, upon receiving a subsequent voting command signal during the voting period, the remote unit 2 will calculate its time slot and transmit any response that the user has input within its assigned time slot on the assigned channel 4 together with a clock timing value, which is the sum of the accumulated time markers and the stored interval count value. The timing for placing the response into the proper time slot is established at the remote response unit 2 on the basis of the passage of time subsequent to receipt of a voting command signal and after the user has keyed in a response.

After the remote response unit 2 has completed its transmission of a response, it will change from a transmission frequency to a receive frequency on the same channel. The remote unit 2 will await an acknowledgment from the transceiver T_{M} that the response has been received, after it has completed its transmission of the user-input information. When the transceiver T_{M} receives a remote response unit 2 transmission, it will then change from a receive frequency to a transmit frequency and send an acknowledgment signal back to the remote unit 2. Upon receipt of the acknowledgment signal, the remote unit 2 will no longer be responsive to repeated transmission of the same voting command transmitted in the same voting period with continually updated interval count signals. The remote response unit 2 will only respond to a different or non-voting command, typically the status command. Alternatively, the system may permit voting multiple times, with the responses being recorded and process according to the time received.

Since the target range for the system is limited to 200 ft. in an exemplary embodiment, sufficient confidence may be obtained that, even with movement of the audience participants within the room, an adequate guard time may be established so that each unit may deliver its response within an allocated timeslot. The assignment of a response unit to an individual timeslot is based upon a registration process, as subsequently described.

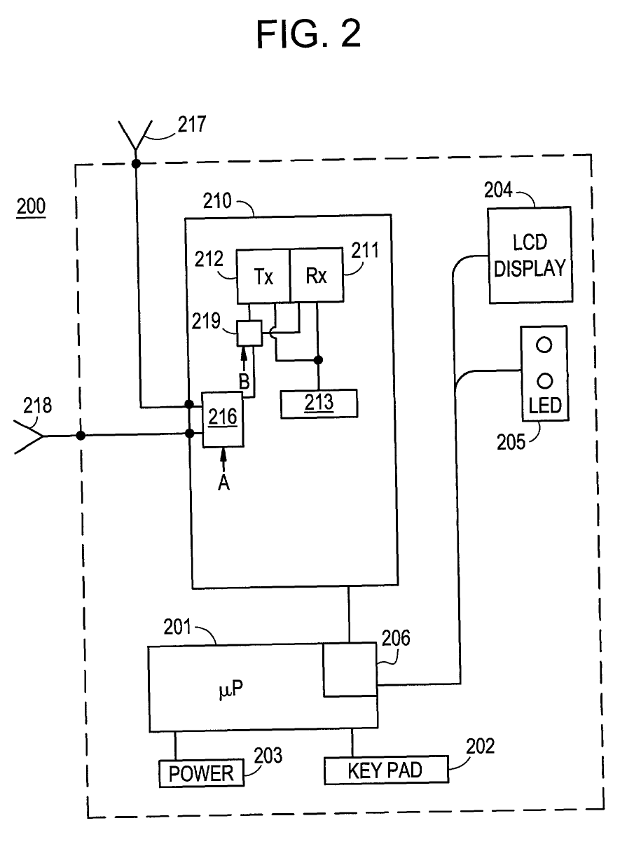

FIG. 2 illustrates in schematic form a single remote response unit 200. The remote response unit 200 includes a microprocessor 201, which is connected to a keyboard, button input or equivalent user input mechanism 202, a power supply 203 and a display section comprising a display LCD 204 and LED 205. The microprocessor 201 also connects to a transceiver section 210 that consists of a single conversion super-heterodyne radio receiver 211 and direct transmitter 212. A phase lock loop synthesizer 213 will be used for the transmitter frequency reference as well as for the local oscillator of the receiver. The unit must be able to rapidly shift between a first frequency and a second frequency for respective receive and transmit operations. User-input data is placed upon an RF carrier using frequency shift keys (FSK/FM) modulation. The microprocessor 201, in an exemplary embodiment, is a single chip device that will control the operation of the transmitter and receiver in the transceiver section 210 and convert the data input by a user via keypad 202 into a form usable by the controller 206 assigned to the display 204/205 and keypad 202. As would be known to one skilled in the art, the transceiver may be assembled from discrete components, although at greater cost than a single chip design.

In the remote response unit illustrated in FIG. 2, the microprocessor 201 may be a microchip PIC 16F73 8-bit microcontroller with 4K words of program memory, and 5 channel A/D capability, with upgrades in memory available. The digital frequency reference is a 4 MHz crystal shared with the frequency synthesizer for the phase lock loop 213. The microprocessor 201 in the remote units 2 preferably are operated with a sleep mode, which is operational except when an audience poll is in process in order to conserve power, except when special functions are involved. As the power supply 203 comprises 3 AAA alkaline primary cells in a preferred embodiment, this feature is highly desirable. Rechargeable cells may be used in alternative embodiment and, in any event, the microprocessor 201 would be adapted to monitor and provide battery level information and report low battery levels. A linear voltage regulator (not shown), which forms a part of the power supply 203, would provide 3 volts of power for all circuits. The receiver 211 within the transceiver 210 has a front end (not shown) that includes a Murata ceramic filter that is operative to filter the receiver input and transmitter output. A solid state antenna switch 216 responds to an input A (provided manually or by processor) and selects among two antennas 217, 218. A solid state operation switch 219 responds to an input B (provided manually or by processor) and selects between transmit or receive functions, the same antennas 217, 218 being used for both purposes. The synthesizer in the phase locked loop 213 may be a National Semiconductor LMX1601 PLL synthesizer. The frequency synthesizer must be able to switch by 10.7 MHz in order to provide the proper transmit and receive frequencies on an assigned channel, an activity that can require approximately 20 ms. The antennas 217, 218 are printed-type antennas that are provided at right angles for spatial and polarization diversity. The short side antenna 218 is loaded for efficiency and matching. The receiver 211 has a single conversion receiver architecture using a Maxim MAX 2440 image reject receiver and VCO integrated circuit. The receiver 211 uses high side LO injection to reduce interference from cellular based stations. In an exemplary embodiment, the IF is 10.7 MHz, allowing use of standard filters. The receiver 211 also includes an IF amplifier, filter, and discriminator, preferably the Phillips SA 636 with Murata SFE 10.7 IF filters to provide IF gain, filtering and demodulation. A National Semiconductor LMV 324 Quad Op Amp and Salen-Key filter configuration provides filtering. The transmitter 212 uses the NEC UPG 2771 integrated circuit amplifier (not shown) for isolation and output coupling.

The LCD display 204 is driven by an Epson SED-1510 IC with 32 lines and 4-way multiplexing. The keyboard 202 has 24 keys in an exemplary embodiment, and is multiplexed using a CD 4094 shift register as a driver, with three columns read through three microcontroller port lines having a wake-on-change feature. This allows the microcontroller 201 to respond to keyed commands, even if in the sleep mode. The keypad 202 is available for user responses in two distinct modes. The first is a “single key entry” mode, which inputs the value of the single key that a user has pressed and transmits that value from the remote unit to the central control unit. The second is a “multiple key entry” mode, which requires that an enter key be pressed after one or more keys are pressed by the user. The mode is dictated by a control byte in a voting command transmission from a corresponding transceiver T_{M} in the central communication unit 3.

The LCD 204 serves as the primary user interface and, in an exemplary embodiment, is a custom liquid crystal display having approximately 100 segments, although other types of display may be used, as is known in the art. LEDs 205 may be provided to indicate the reception of registration commands, or other information.

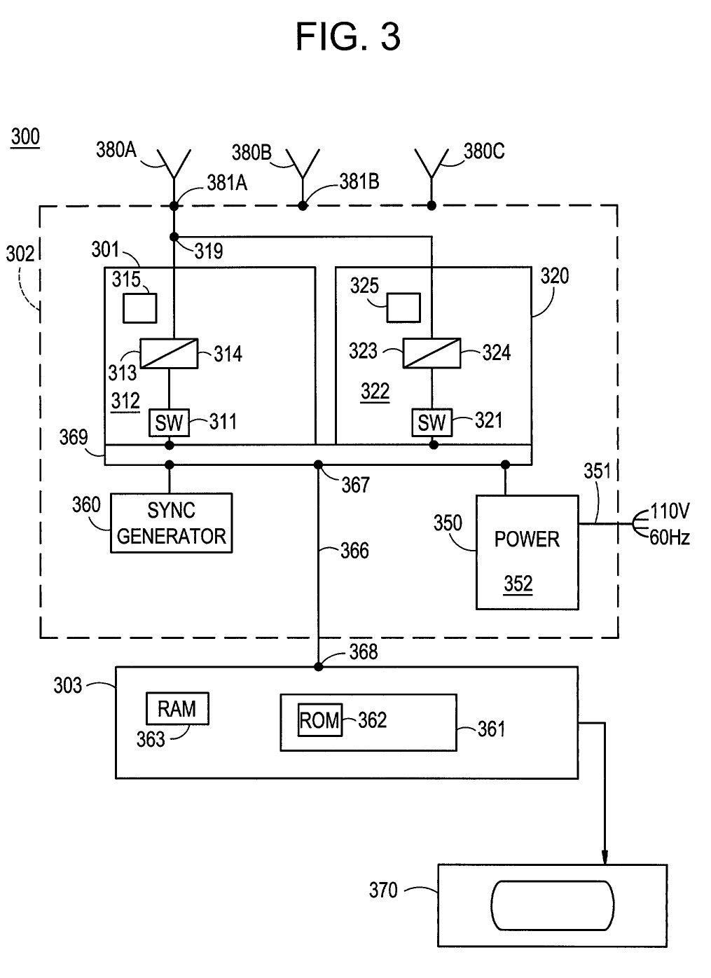

A schematic arrangement of the central control unit 300 is illustrated in FIG. 3 and includes the communications section 301, having in an exemplary embodiment two transceivers 310, 320 and a processing unit 303, which preferably is a laptop PC. As previously noted, a separate processing unit is not required, but its functions may be provided by processors that are integrated into the communications section 301 or its transceivers. If separately provided, the processing unit 303 is connected to the communications section 301 via a data link 366, which may be a USB link, or other wired or wireless (e.g., Bluetooth or IR) data link known in the art. The processing unit 303 is conventional (but for specialized applications for operating the audience response system) and can control a variety of applications, such as power point, as well as a variety of peripherals, such a projectors. The processing unit 303 will contain an appropriate quantity of memory in the form of ROM 362 and RAM 364, and may be connected to an appropriate operator visual interface, such as a display 370.

In an exemplary but non-limiting embodiment, the communication section 301 consists of a portable enclosure 302 with slots provided to mount two transceiver modules or cards 310 and 320, although there clearly may be a larger enclosure that can house a greater number of transceiver cards. A common power supply 350, connectable to a conventional 110V, 60 Hz source with battery backup, is provided to power the communication section 301, including any one or both of the two transceiver modules 310 and 320. The selection of the number of modules for a given audience response event will depend upon the number of participants. The activation of the appropriate number of transceiver modules will be determined by the event organizer and will be effected by activation of switches 311 and 321, based upon the understanding that each transceiver module would support up to 256 remote response units in one poll of five to six seconds. A software command or activation of a switch will connect each transceiver module to a common sync generator 360 (which may be a single generator or a generator on each transceiver card that is designated as the master), and the power supply 350. By activating more than one transceiver, the program facilitator has an option to allow one transceiver module to support a second set of remote response units in a second time period, extending the time to up to 11 seconds or 500 units, including a one second time synchronization pulse between groups. Up to 4 sets of slots may be assigned to each transceiver so that up to 1000 remote response units can be supported, though requiring a response period of over 20 seconds. If fewer than 256 remote response units 2 are registered for a transceiver module, the response time for the associated group of remote response units can be reduced below 5 seconds.

Each transceiver module 310 and 320 consists of an electronics board 312, 322, mounted in a plug-in enclosure (not shown). The transceiver electronics board has a sensitive receiver 313, 323, an FSK transmitter 314, 324, frequency synthesizer (not shown) and a microprocessor 315, 325. Because the transmit and receive frequency at the remote receive unit must change by 10.7 MHz, the frequency synthesizer in the transceiver module maintains the same frequency for both its transmission to and reception from the remote response units. The transceiver can operate over the full 902-928 MHz unlicensed ISM frequency band, although it is apparent to one of ordinary skill that other licensed frequency bands may be used. Two-antenna spatial diversity for reception is provided by antennas 380A, 380B and a single antenna 380C is provided for transmission, in a manner known in the art. For very large rooms, the most efficient way to extend the coverage area will be to use both of the transceiver modules 310 and 320. The antenna connections can be printed circuit board mount SMA connectors or can be wired to external connectors. Each transceiver board will be mounted in the enclosure which will have connectors for power, serial data and for indicator LEDs. BNC antenna connectors 381A, 381B will be provided at the ends of the top surface of the enclosure, and fold-down antennas may be provided to allow the base transceiver enclosure cover to be closed for easy transport. AC power for the base transceiver will be connected with an internationally approved power entry module with an IEC power cord 351 connector, fuses, and EMI filtering (not shown). The internationally approved power supply 350 will be used to allow operation from 100 to 240 v AC at 50-60 Hz line frequency. A sealed backup battery 352 will be provided to maintain power for a desired period of time, if the main power source is interrupted.

Each of the transceiver modules includes a respective microprocessor 315, 325, 335, 345, which controls frequency, operating mode, antenna selection, and communications. Each microprocessor communicates with the processing unit 303 via link 366 connected to USB ports 367, 368. For practical considerations, no more than four transceiver modules will share a USB port, to ensure higher performance in transfers to the processing unit 303. The USB links are connected to the base transceivers via a half duplex interface 369. In the standard transceiver system, the USB interface allows up to four transceiver modules to share a single USB connection, although more than one USB port could be assigned (thus expanding the number of transceivers) provided the underlying USB/Serial converter has available COM ports to assign. Data will be transferred from the transceiver modules 310, 320 to the processing unit 303 as the data is received from the remote response units 2. The processing unit 303 includes a microprocessor 361 having a ROM 362. Connected to the microprocessor 361 is a conventional power source (not shown). The microprocessor 361 also connects to a main memory 363, which may be a RAM or other read/write storage device (e.g., EEPROM). Notably, the microprocessor unit 315, 325 in each respective transceiver module includes memory to temporarily hold the data received from each remote unit 2 with which it communicates, pending downloading to the processing unit 303, particularly when the processing unit 303 is not operational, an event that is likely to exist with a Windows operating system.

The processing unit 303, whether embodied in a desktop, laptop or specialized PC, plays several important roles in the audience response system, including control of the registration, voting and overall system operation, as well as auxiliary functions such as display of questions, prompts and results.

The processing unit 303 will control the registration process that is utilized in an exemplary embodiment of the present invention and establish a master database connecting the serial number of each remote response unit 2 with an assigned channel (based on a channel number or ID) and time slot, and with user-entered information, such as a log-in number. The processing unit 303 software will be responsible for balancing the number of required remote response units 2 over the number of available transceiver modules (310, 320), and will assign an appropriate number of units to each transceiver accordingly. The software also will be responsible for filtering out any responses received from non-registered remote response units.

In addition, the processing unit 303 will control a voting process, by issuing a series of commands that are operative to start, maintain and end the process at one or more transceivers. In beginning the voting process, the processing unit 303 will generate a command to selected transceiver modules 310, 320 to initiate a request for response from their respective remote response units 2. The processing unit 303 will also issue a command that will cause the transceiver to send a signal to its respective remote response units 2, indicating whether the single or multi-key mode is to be used. A command also may cause the transceivers to terminate an existing voting session. The software in the processing unit 303 will also enable the selected transceiver modules 310, 320 to be polled for responses and to store the data that has been received. The processing unit 303 software applications will handle the data that has been acquired and effect its analysis and presentation, including display on a monitor 370 or via a computer projection system.

The commands issued from the processing unit 303 to a transceiver module 310, 320 will have a protocol based on a combination of a command start byte (H′21′), command byte and argument (with no checksum). The transceiver responds with an acknowledgment of the command, by sending a start byte (H′FE′), a copy of the command byte, single acknowledge byte and a sequence number generated at the processing unit 303. The sequence number permits the system to properly allocate acknowledgments, to issued commands and avoid overlap and conflict.

When the processing unit 303 controls the data transfer from the transceiver modules 310, 320, it can control the timing with which the two modules operate. The processing unit 303 will check each transceiver module 310, 320 in turn for data that is available. The data rate as a result of a serial to USB conversion will be at least 38.4 Kb.

The processing unit 303 will include software needed to support multiple base transceivers for large rooms. In such case, the processing unit software will have to include a capability of removing redundant messages that are received from multiple transceivers.

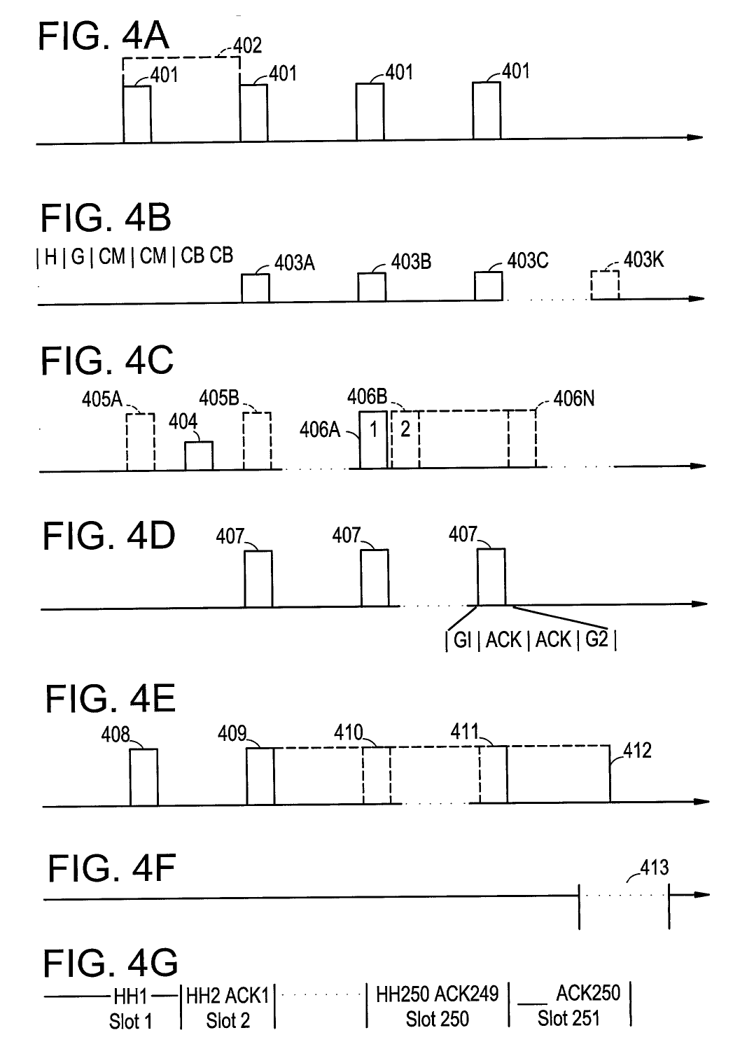

The timing and content of various communication activities in the audience response system of the present invention are illustrated in FIGS. 4A-4J, but these examples are not presented to scale or in precise relation to each other. These activities include the transmission of commands from each transceiver T_{M} in a central communication unit 3 to its corresponding remote response units 2, particularly for purposes of polling the remote response units for information that has been input by a user, and the registration of units with a corresponding transceiver unit. The polling protocol adapted by the present invention is based upon each operational transceiver module 310, 320 in the central communications unit 3 issuing a series of voting command signals to all of the remote control units 2 that have been assigned a particular channel and time slot on the channel to which that transceiver is tuned. The timing of all requests for response by registered remote response units 2 is based on the transmission of particular commands from the corresponding transceiver 310, 320 over one of the channels that has been selected for communication.

Assuming that there has been a registration process completed and that a transceiver T_{M} in a central communication unit 3 and its corresponding registered remote response units 2 have been switched to a single channel, according to an assignment by the processing unit 303, the transceiver T_{M} will issue periodically a null command that will act in the nature of a timing mark or synchronization pulse, although it should be understood that any command issued by the transceiver can be used to provide synchronization. As illustrated in FIG. 4A, this null command signal 401 has a duration long enough to allow the receivers in all remote response units 2 to detect the signal and establish synchronization. Based upon the number of remote response units 2 that are to be registered and the typical size of the area within which the audience will be located, 200 feet from the central control unit in an exemplary embodiment, the period 402 between the null commands 401 is selected so that all remote response units 2 within the planned area would be able to detect the null command signal 401. In an exemplary embodiment, the null command signal will have a header that is sized to permit the signal to be easily detected. Further, by having periodic transmission of the null command signal 401, the remote response units 2 will require only about 10 milliseconds to detect the command signal. The null command signal will be transmitted from the central communications unit 3 with sufficient frequency (in an exemplary embodiment, every 1.3 sec) so that accurate clock timing can be established at each remote response unit 2 and maintained with respect to the clock timing at the central communications unit 3.

Referring again to FIG. 4A, the signal 401 that is transmitted from each of the transceivers in the central control unit 300 to its respective remote response units 2 will have a header (H), followed by a command byte indicating that the remote response unit is to be in a particular mode of operation. The header will consist of short pulses at 5 kHz for 10 milliseconds, followed by a 0.25-millisecond gap (G) for synchronization. This is followed by two copies of a command byte (CB), with several types of commands being provided. One command is a null command as previously explained, requiring no response. A second command is a voting command for a “single key response”, requiring a single key response from the user. Yet another voting command is a “multiple key response”, requiring a multiple key response from the user. A further command is a “register” command, requesting registration, in a manner to be subsequently described. Repeated transmissions of the same command and changes from one command to another are used to control the operation of the remote response units. An interval count signal also may accompany the command, as previously described.

The initiation of a voting period may be established by changing the null command signal to a voting command signal requiring a particular keyed response, such as a “single key response” or a “multi-key response.” As exemplified in FIG. 4B, a first voting command 403A, when transmitted by a transceiver to its respective remote response units 2 on an assigned channel, can open a voting or response period and act to set each remote response unit 2 into a mode where it can respond to any identical and subsequently received keyed response command 403B-403K by transmitting data that has been input by a user (together with a time stamp, carried in the transmitted bits). When a remote response unit receives the first voting command, an indicator (not shown) may advise the user that a response can be keyed-in, and following the completion of the input to this or any other known type of user input by the user, the next received voting command will cause the input to be transmitted. Thus, until a remote response unit first receives voting command 403B, a command cannot be entered and once it receives a voting command 403H subsequent to entry of the response by the user, it will transmit the keyed input that has been entered by the user prior to receipt of voting command 403H. Notably, the response mode includes a “respond once” mode in which a subsequent response is locked out, and a “respond many times” mode, in which responses can continue to be sent during the current response session.

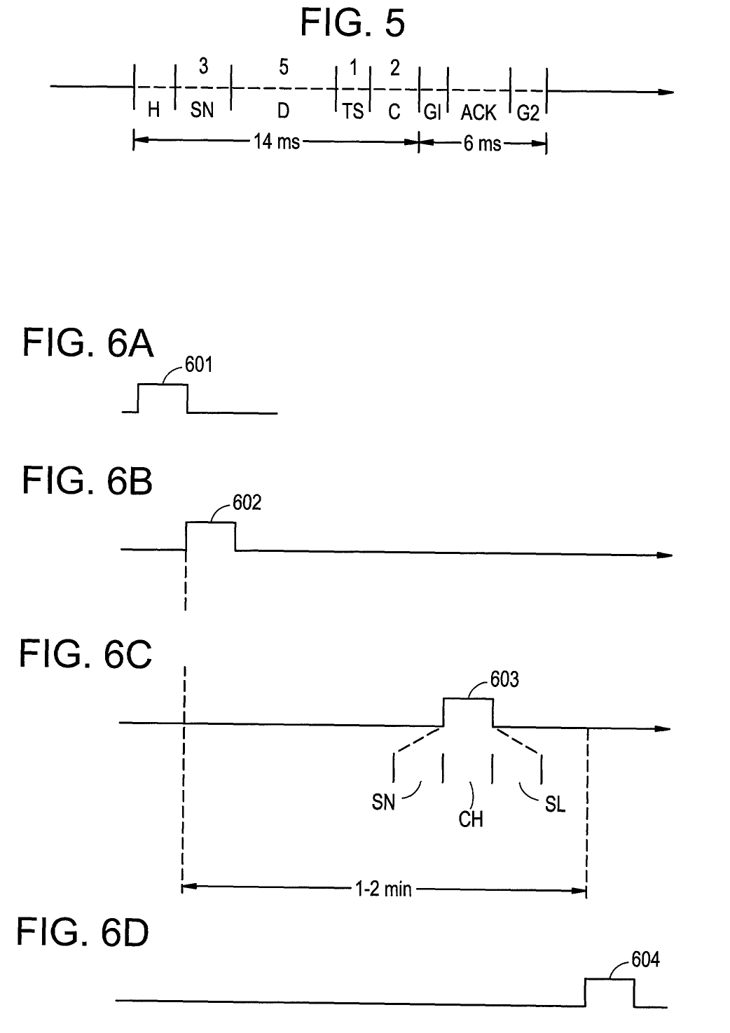

Each voting command transmitted by the central control unit establishes a response frame that contains all of the assigned time slots for all remote response units, such that the periodic transmission of voting commands establishes a sequence of response frames. As illustrated in FIG. 4C, when a user's input 404 to a remote response unit 2, after receipt of a first voting command 405A, is followed by receipt of a second voting command 405B, the processor 201 in the remote response unit 2 will initiate the transmission of a user-entered input to the assigned transceiver in central communication unit 3. The response is transmitted in a time slot and on a channel previously assigned to that remote response unit during a registration process. FIG. 4C shows that the remote response unit 2 that is assigned to the first time slot 406A will provide its transmission, which in an exemplary embodiment would be an 11 byte burst, requiring 14 milliseconds for transmission. As also illustrated in FIG. 5, the burst comprises a header string (H) of 5 kHz square waves followed by a 3 byte serial number (SN), 5 bytes of data (D), a single time stamp byte (TS) and 2 bytes of checksum/CRC (C). At the remote response unit 2, the transmission of the burst would be followed by a 6 millisecond period during which an acknowledgement of a previously transmitted burst may be received at the remote response unit. The acknowledgement signal is divided into a 2-millisecond guard band (G1), 2-millisecond acknowledgement consisting of two copies of the same byte, and a 2-millisecond guard band (G2). The acknowledgement options are: (1) ACK of transmission and valid entry, (2) ACK of transmission but invalid entry, and (3) NAK of transmission.

As illustrated in FIG. 4E, the response period during which a polling process of all remote response units 2 is conducted may involve multiple response frames that are established by the transmission of voting command signals 408-411 by the transceiver in the central control unit 300. It is possible for all N remote response units 2 to receive the first voting command, to have the user enter data and to respond to the second voting command 409 in a single response frame by transmitting the input data in the N pre-assigned time slots following receipt of the voting command 409. However, in practice, the transmission from remote response units will occur over multiple response frames defined by voting commands 409, 410, 411 due to (1) a remote response unit missing the first voting command 408, causing a subsequent voting command to change the unit's mode, (2) a delay in a user inputting a keyed response, and (3) a remote response unit missing a voting command immediately subsequent to the user input, but receiving a later received voting command. Thus, during the voting period that begins with the transmission of a first voting command 408, the several remote response units may transmit over a pre-assigned channel and in a pre-assigned time slot, but during different transmission periods.

The transmission period for each remote response unit begins with its receipt of a second voting command (409, 410, 411, etc.), which causes the processor 201 to count from the receipt of that second voting command a predetermined duration that is related to the assigned time slot for that unit, and then to cause the user input to be transmitted to the central control unit 300. The central control unit 300 will receive the transmissions on the assigned time slots (1−N) of a single channel in a predetermined order, based upon the transmission times assigned on the basis of the registration process.

The receipt of data from all remote units 2, and acknowledgment by the central control unit 300 is followed by a period 413 of data processing and display, as indicated in FIG. 4F.

The data transmitted by the remote response units 2 to their associated transceiver T_{M} in the central control unit 300, in response to a poll of all the respective response units 2, may be temporarily stored in the transceiver's microprocessor, and at a predetermined time may be relayed to the processing unit 303 in its raw form, of serial number (3 bytes), data (5 bytes), time stamp (1 byte) and checksum (2 bytes), accompanied by a start byte and command byte generated by the transceiver. The period of temporary storage may vary, depending on the manner in which the audience response system is used, and as an alternative, the data may simply be sent as a stream without storage. This same protocol may be used to convey other responses by the remote response units to commands or inquiries from the processing unit 303 via the transceivers 310 and 320.

The registration process underlies the method used to acquire centrally the responses from multiple participants. In this process, an operating channel and a time slot, within which each participating remote response unit 2 send its data following issuance of a voting command signal, are assigned. In an exemplary embodiment, the registration process will be implemented as a transition from a sync or timing mode, during which a transceiver is sending null commands on an assigned channel and any remote response unit tuned to that channel is receiving the null commands. The registration process may be initiated by a transceiver changing from the sync mode to a registration mode by sending an appropriate command to all remote response units 2 that are tuned to that predetermined channel, which may be a previously assigned channel 4. The registration initiation command 601 that is sent to the remote response units 2, may be generated under operator control of the processing unit 303, or automatically in response to other predetermined criteria. Regardless of how the registration process is started, with reference to FIG. 6B, the remote response unit 2 is operative to send a registration request signal 602 on the same channel on which it received the command (assigned channel 4). The request signal 602 illustrated in FIG. 6B will contain information identifying the remote response unit with a multi-byte unique code, for example, the serial number of the unit. When the central control unit 300 receives the signal 602, the processing unit 303 will make an assignment of a channel and a slot within the channel and transmit that information along with the unit's unique code to the remote response unit 2 making the request via a signal 603. As illustrated, the signal 603 may comprise a byte identifying an assignment of an operating channel CH (1 of 17 in the exemplary embodiment) and a byte identifying a time slot TS (1 of 256 in the exemplary embodiment) in the assigned channel. In the exemplary embodiment, a 3-byte serial number SN (approximately 16 million possible numbers) also is transmitted to the remote response unit 2. The same channel, slot and serial number information is stored in the memory of the processor 315, 325 in the corresponding transceiver 310, 320 of the communication unit 301 and in the memory 363 of the host processor unit 303.

While ordinarily the remote response units 2 will be pre-registered, where an automatic registration is needed at the start of an audience response session or during the session, only a short time (typically, a minute or two) would be required to complete the process where there is a full set of 256 remote response units in use. Slots may be assigned sequentially, in a exemplary embodiment, so that only the number of slots registered will be used by the processor to minimize the response time. Following an initial registration process, the system also will permit additional registrations under manual control. Also, a registration may be commanded if the processor detects interference on assigned communications channels and it decides that a new registration is required in order to minimize the interference. If a response unit has already been registered, in an exemplary embodiment, that unit may retain the registration unless commanded to re-register by the base transceiver.

Manual registration is typically used to add a specific number of remote response units to an existing registered group that is participating in an audience response event. The event facilitator will know that new participant(s) have arrived and that they must be added to the group. The registration process would normally be conducted during a coffee break or lunch, so that the voting process will not be disturbed, although it clearly can be performed at any non-voting time. With reference to FIG. 1, according to the manual registration procedure, the facilitator can use the keyboard 10 to instruct the PC 6 to initiate a manual registration process for one or more transceivers, whereby the PC 6 will send a command to a transceiver T_{M} to start the manual registration process. The PC 6 will also provide the transceiver T_{M} with the maximum total number of remote response units that are to be registered. The registration command will cause the transceiver to issue a manual registration command to the remote response units on a pre-assigned channel. The remote response unit(s) 2 that are to be added must already be set to the pre-assigned channel, either manually by a user after an announcement by the facilitator, or automatically upon the remote response unit 2 being turned ON. Since the manual registration process typically is intended to add new remote response units to an established session, the slot count for new remote response units will begin from the last highest slot number.

Referring again to FIG. 2, the remote response units 2 may have a visual indicator, such as LED 205, which indicates the reception of the registration command signal from a transceiver on a predetermined channel and is kept on until the registration process is completed. The remote response unit may also have a registration key (a specialized key or a predetermined combination of keys on keypad 202), that may be pressed so that a registration request signal 602 will be sent on that same channel to the transceiver T_{M} uniquely identifying the remote response unit 2. The receiver 211 in the remote response unit will receive the registration reply message 603 sent by the transceiver, again on the same channel to the remote response unit 2, and the processor 201 will store the registration information in memory 206. Upon receipt of the message 603, as an announcement to the user, the processor 201 in the remote response unit 2 will provide an indication, such as an extinguishing of the illuminated LED 205, in order to indicate that the remote response unit 2 is registered.

In order to ensure registration of all new units, the conference facilitator will advise those users who units are to be newly entered into the system to set the reception to a particular channel in any of a variety of manners known in the art, e.g., by pressing/holding a predetermined key combination, pressing corresponding number keys or the 10 key and a number key for numbers above 9 and holding them held for several seconds. The remote response unit receiver will go to that channel as indicated by the input number. The remote response unit 2 will then receive the request and respond to the manual registration request. Of course, if the remote response unit 2 to be manually registered is not tuned to the channel the transceiver is using, the remote response unit will turn off after a predetermined period of time without receiving the manual registration request 601.

In an exemplary manual registration process, the unique serial number of the remote response unit 2 is used to avoid mix-ups if two remote response units are trying to register at the same time.

As previously noted, transceivers T_{M} will be instructed by the PC 6 to register only a predetermined number of handsets. Once that number is reached, the PC 6 may initiate the activation of another transceiver T_{M} to take further registration requests.

An automatic registration process is the normal mechanism for registration, because the registration information from previous sessions is stored in EEPROM memory, making the registration “permanent” unless overridden by manual or automatic registration. As would be understood by one skilled in the art, the stored registration information may be used to facilitate the manual registration process as well.

The automatic registration process may be based on a protocol that requires the remote response units, when turned on (by an ON/OFF switch or by pressing any key), to go to the channel for which they were last registered or to a special command channel (e.g., channel #0), especially if they were not previously registered on a particular channel. If no transceiver signal is received within a brief period of time (e.g. 30 seconds) on the previously registered channel (if any) the remote response unit may automatically change to a predetermined channel (e.g., channel #0). That predetermined channel may be one announced by a session facilitator and entered by a user's operation of the keypad, as previously noted. In any case, if no signal is heard after another predetermined period (e.g., 30 seconds), the remote response unit may automatically turn off to conserve the battery.

With reference again to FIG. 3, when engaging the automatic mode, the processing unit 303 in the central control unit 300 can command a particular transceiver T_{M} to issue a registration command to the remote response units on the assigned or predetermined channel (e.g., channel #0). The processing unit 303 will also provide the transceiver with the maximum number of handsets to register. The registration command will clear the registered status of the handsets for the selected transceiver T_{M} and will cause the transceiver T_{M} to start the slot count from 1. Each operational response unit 2 will respond to a auto-registration command with a registration request message on the previously assigned channel or on the common command channel 5 after a pseudorandom delay to assure that the remote response units do not all transmit at the same time. An LED 205 on the remote response unit will light when the auto-registration request message is received.

When the transceiver T_{M} receives a registration request message on the previously assigned channel or the common command channel, and assuming that the number of remote response units to be registered is not exceeded, the transceiver will record the serial number of the remote response unit 2, and assign a channel and the next slot number in a reply message to the remote response unit 2. Preferably, the remote response unit 2 will be assigned to a previously assigned channel (and even slot) but, depending on programming, may be assigned to a different channel and/or slot. If the remote response unit 2 receives the registration reply message, it will indicate a completed registration by extinguishing the LED 205. If not, the remote response unit 2 will try again. The transceiver will check registration requests for duplicates and send back a message with the original slot assigned, in order to avoid using up slot numbers even if the registration reply message is missed by the remote response unit.

When the desired number of remote response units 2 is registered, the processing unit 303 can issue a command the transceiver to “request handset status” to confirm that the desired number of units 2 is registered. Then, if desired, the processing unit 303 can command the registered remote response units to “move to another channel”. The transceiver and all of the units will be moved to the new specified channel (automatically in one embodiment or manually in another) and a voting procedure can then be conducted, as desired.

In either type of registration, if the request for registration is not acknowledged, the remote response unit 2 may be programmed to try again after a pseudo random delay, until an “end of registration” command is issued by a transceiver on the designated channel, as indicated by pulse 604 in FIG. 6D.

The registration of a remote unit 2 with a particular transceiver T_{M} in a particular central control unit 3 may be in a persistent registration mode in which a registration information (channel and timeslot) is retained in RAM or other memory, such as an EEPROM, from one session to another. This feature will allow remote response units 2 to be set up in advance of a session, or to allow remote response units 2 to be used repeatedly in the same environment, such as a classroom, where re-registration is unnecessary. If needed, a re-registration command that is issued by the central control unit 300 in order to initiate re-registration of the remote response units on a new channel, can be facilitated by using the previously assigned slots.

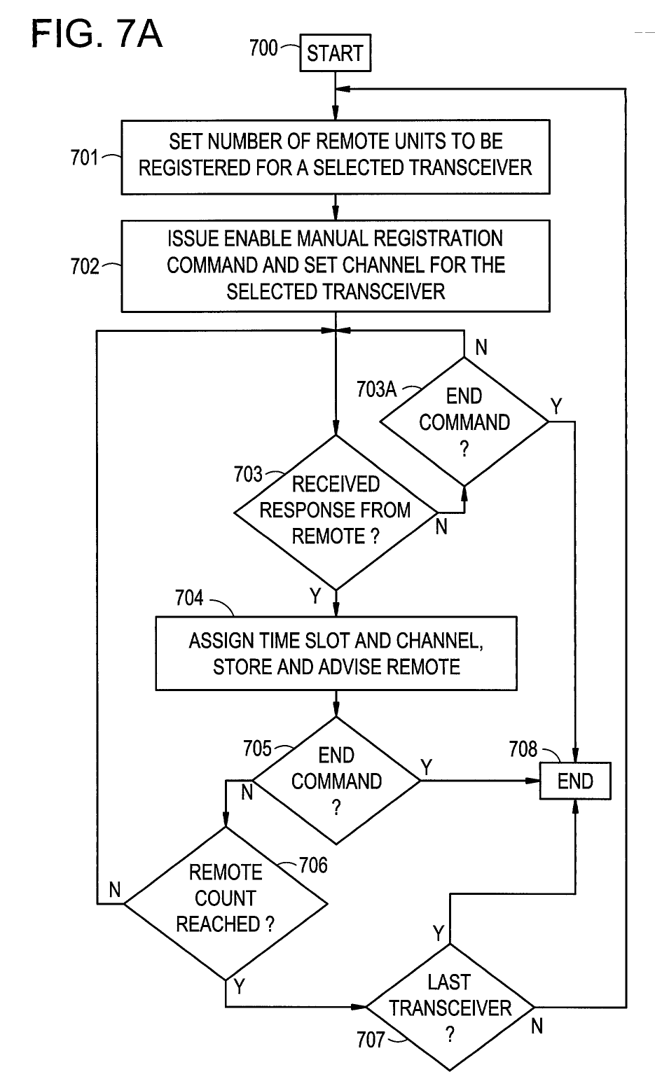

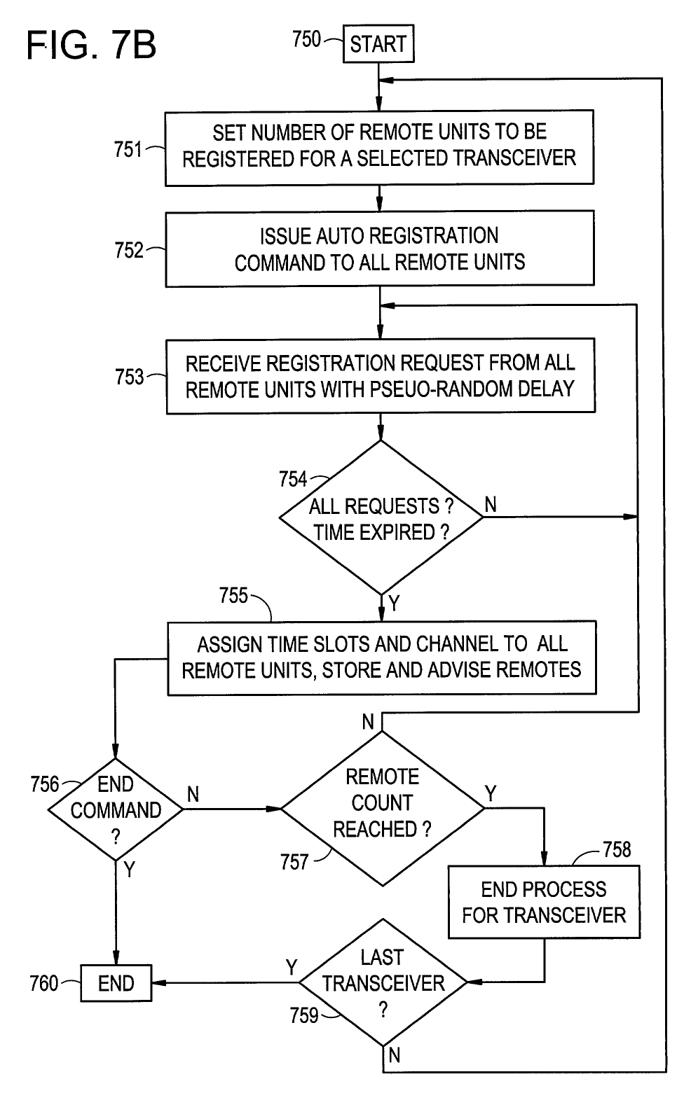

The operation of the processing unit 303 and the transceiver 302 in the conduct of a manual registration operation by the central control unit 300, in accordance with an exemplary embodiment of the present invention, is illustrated in the flow diagram of FIGS. 7A. Initially, in step 701, the processing unit 303 acting under operator input sets the number of remote response units 2 to be registered for a selected transceiver (e.g., 310 or 320) to be equal to the currently registered number of units on a currently selected channel plus the number of new units to be added by the manual registration process for communication on the channel. Of course, the current channel number has already been input to the new hand held units. Then, in step 702, the transceiver 302 issues an enable manual registration command on the existing channel to all remote response units 2 tuned to that channel, including the unregistered units. In response to the receipt of this command at all of the remote response unit 2 that are tuned to the channel (both registered and unregistered), an LED 205 or the like is illuminated. At the remote response units to be added, the operator presses a predetermined key sequence or a special key on the keypad to initiate registration over the same selected channel. At the central control unit 300, the processor unit 303 or the transceiver itself makes a determination as to whether a response (including an unregistered unit serial number) from any remote response unit 2 has been received in step 703. If no response is received, a continual search is conducted until a manual command to end the registration is received (step 703A), at which point the process ends at step 708. If a determination is made that a registration response for a new unit has been received at the central control unit 300 in step 703, the relevant transceiver in the communication unit 302 issues a message assigning a channel and timeslot to the remote response unit 2 and stores the information received from the remote response unit (serial number) along with the time slot and channel to which the new remote response unit 2 is assigned in step 704. An acknowledgment (using the unit serial number) also is returned to a remote response unit as its registration is completed and, on receipt, the remote response unit will extinguish the LED 205 (LED on other remote response units will remain lit). The processing unit 303 and the transceiver may be operative to store the registration information, including a count of the number of remote response units registered as each response is received. Unless there is a manual command to end the registration process detected in step 705, so that the processing ends at step 708, the process continues and a determination is made in step 706 as to whether the desired count of the number of registered units for that transceiver has been reached. If not, the process continues in a loop to the beginning of step 703 and when the remote count has been reached in step 706, the processor 303 can command the transceiver to end the registration activity at step 708 and advise the remote response units 2 that the registration process is concluded. If desired, after step 706, the process may move to a determination in step 707 of whether the last transceiver has been registered. If not, the processor 303 starts the registration process for the next transceiver by continuing in a loop to the beginning of step 701. If the last transceiver has been registered, the process moves to the end at step 708. At the time the process ends for a given transceiver or for all transceivers, a command may be sent on the assigned channel(s) to all corresponding remote response units 2 to turn off their respective LEDs 205 (if still ON).

In the automatic registration process, which may be implemented at the start of an audience response session or, or to enable more or fewer transceivers to be registered during a session, the sequence of FIG. 7B will be followed at the central control unit 300. In the initial step of the sequence, 751, the processing unit 303 sets the total number of remote response units 2 to be registered for a selected transceiver, as in the manual mode. Next, in step 752, the selected transceiver T_{M} in the communications unit 302 issue an enable automatic registration command to all of the remote response units 2 via the channel to which the units were previously assigned or a pre-assigned channel (which may be channel #0). The communication control unit 302 then awaits receipt of registration request messages from the remote response units 2 on the same channel indicating that the command was transmitted. The request messages will be issued by the connected remote response units 2 with a pseudo random delay in order to minimize collisions among the messages from responding units 2 at the transceiver T_{M}. The pseudo random delay may be based upon any of a variety of techniques, but an exemplary embodiment is based on the low byte of the unit's unique serial number. In step 754, the central control unit 300 determines whether all of the connected remote response units 2 have provided a request message and, if not, will continue to monitor receipt of the request messages from the remote response units 2. After the remote response unit request messages are received, the processing unit 303 may assign a transmission channel (particularly if the communication was over a common channel or a new channel is desired) and slot to each of the associated remote response units, and store that information in correlation with the unit's unique code (serial number). Programming can provide that the channel and slot are most likely to be those previously assigned to a previously registered unit, but they also may be different, depending on load, programming and other factors considered relevant to system set up. This assignment process will continue until a determination is made in step 756 that a command to end has been received, at which point the process will end at step 760. If an end command has not been received, the central control unit determines whether a predetermined number of remote response units 2 have been registered in step 757. If not, the process proceeds in a loop to the beginning of step 753. If time has elapsed, in step 758, the registration is ended automatically for that transceiver and a determination is made in step 759 as to whether other transceivers must be registered. If additional transceivers are required, the process returns to step 751. However, if no further transceivers are required, the process ends.

As in the case of manual registration, the LED 205 on each remote response unit will be illuminated at the beginning of the registration process and will be extinguished either when an acknowledgment of registration is received from the central communication control unit 3, or a command to end the registration process. The light will provide the facilitator an opportunity to query the audience during the registration process as to whose unit has not yet been registered.

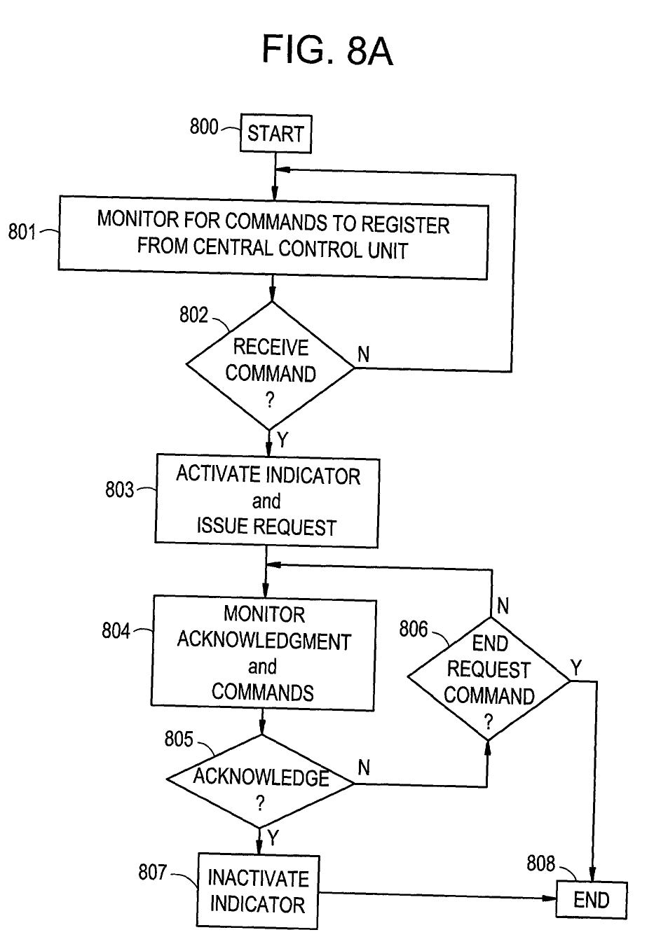

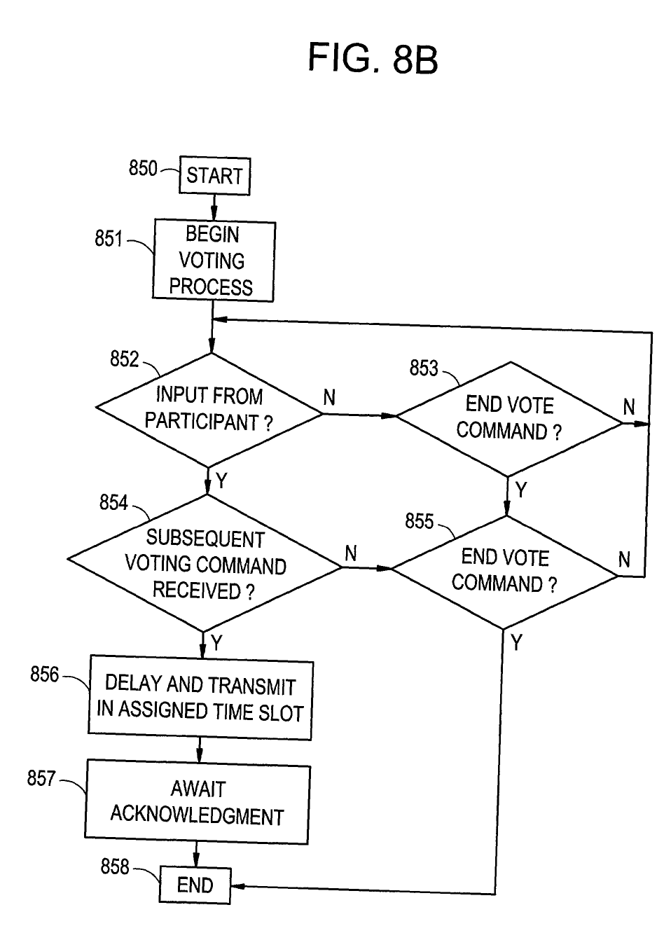

The flowchart illustrated in FIG. 8A identifies the steps conducted at the remote response unit 2 during the registration process. The process will start at step 800 when a unit 2 is turned on, or a particular key or combination are activated. In step 801, the remote response unit 2 will monitor transmissions from the central control unit 300 and, upon a determination that a command has been received in step 802, the registration indicator (LED 205) will be illuminated in step 803, and a request for registration is issued by the remote response unit over the assigned communications channel. In an automatic registration process, the request is generated with a pseudo random delay in order to have the request issued with a timing that will avoid contention at the transceiver. In a manual registration, a user simply activates keys and the typically small number of added registrants will not create a contention problem. Thereafter, in step 804, the remote response unit will monitor the channel for receipt of an acknowledgement signal or other commands from the central control unit 300. In step 805, a determination is made as to whether the acknowledgement has been received. If no acknowledgement has been received, the process proceeds in a loop to step 806 for a determination of whether an end request command has been received. If no end request command has been received, the loop proceeds to the beginning of step 804; but, if an end request command has been received, the program ends at step 808. If an acknowledgment has been received according to step 805, the process proceeds to step 807, where the previously activated indicator (preferably LED 205 on the unit), is extinguished and the registration step comes to an end at step 808. Thereafter, the unit is in a standby condition awaiting receipt of a null command to provide synchronization with the central control unit or other commands to query the remote response unit 2 and request transmission of an input provided by the user.

For example, in the case of either manual or auto registration, once the remote response unit is assigned a channel and a timeslot by the central control unit 300, it may be sent a “log in” command requesting entry of a unique user ID to identify a particular user. In such case, the user may be asked to enter a user ID number (such as a social security number, phone number or the like). This request will be made outside of the usual voting period, and may be complied with asynchronously. To effect this entry, the user will be instructed to push a designated LOG key or keypad combination, and the word LOG will appear in the LCD 204 of the unit. The user ID number is then entered via the keypad and the LOG key is pushed and held in order to store the entry for downloading by the central control unit 300. Subsequently, an operator at the central control unit 300 can command a transceiver to request all remote response units to provide the log-in numbers. The user ID number, along with the unit's unique ID number previously registered in the central control unit 300 is sent to the assigned transceiver over the assigned channel in the assigned timeslot.

A “status report” command also may be issued thereafter at any time outside a voting period, to query for the status of a unit. In response, the remote response unit 2 unique serial number, a remote unit number (entered by a user pressing and holding a predetermined key and then entering up to two bytes), slot number and the battery status may be transmitted to the transceiver.

Another important command is the voting command, as previously described, that is used in connection with a voting process at the remote response unit, as illustrated in FIG. 8B. In an exemplary embodiment, the voting process may begin at step 850 by the remote response unit receiving null command signals from the central control unit 300, in order to maintain sync while awaiting an operational command. Where the command received in step 851 is a voting command, which may be one of a single key response command or multiple key response command, the remote response unit will begin a process of checking for a user input in step 852. If no input is received, the process continues in a loop to the beginning of step 852 but will check in step 853 as to whether an end voting command has been received, in which case the process will end at step 858. If there is no end voting command, the process proceeds in a loop back to step 852. As soon as an input from the user is detected in step 852, by operation of a single key or multiple keys followed by an enter command, the process proceeds to looking for a subsequent voting command in step 854. Voting commands are transmitted by the central control unit 300 on the assigned channel at frequent periods during the voting period, so there should be little delay in receiving a voting command subsequent to a user entry of a vote or response. However, in anticipation of a possible communication failure or termination of the voting process, the remote response unit will check for an end of voting period command in step 855. Such event will end the voting process, but in the absence of such event, the process will continue in a loop, looking for a second voting command. Upon receipt of the second command, in step 856, the remote response unit processor will implement an appropriate delay corresponding to the assigned time slot, and will transmit the user input in that time slot. Thereafter, the remote response unit will await an acknowledgment, at step 857, which will end the voting period for that unit at step 858 in a “vote once” mode. As an alternative feature that is not illustrated, the process may permit continuous monitoring in a “vote many times” mode.

With reference to FIGS. 2 and 4G, the remote response unit 2 includes a frequency synthesizer (not shown) that must change its frequency by a large increment in order to change from a transmit to a receive mode, as already noted. This change may take several milliseconds to stabilize. Accordingly, it is desirable to minimize the time between the remote response unit transmitting a packet of data and the slot for the next remote response unit. The synthesizer in the transceivers T_{M} in the central communications unit 3 does not change frequency between receive and transmit so it does not have the same problem. In order to solve the problem in the remote response unit 2, the acknowledgement for a given remote response unit 2 is delayed by one slot time, as illustrated in FIG. 4G. This will allow the frequency synthesizer in the remote response unit 2 a full slot time to change frequency. The sequence for several remote units is represented by the sequence illustrated in FIG. 4G.

As previously noted, in order to identify the speed at which each participant responds to a question or issue, the invention also includes a time marker system that identifies the time between the start of a response period and the time a participant enters a response. The time marker is accumulated in the remote response unit from the start of the response period in tenths of a second, until a key is pressed for a “single key response” or the enter key is pressed for a “multiple key response.” This time marker value is sent along with the response, and the host computer can determine that first response(s) on the basis of the time marker value. However, the remote response unit may not receive the first synchronization signal commanding the start of the response period. This would be a disadvantage to a user based on factors such as radio noise that are not in his control. According to a feature of the present invention, the transceiver T_{M} in the central communication control unit 3 will send an interval count signal with each subsequent null or other command in the response period to indicate the number of 1.3 second intervals since the response period opened, so that if a remote response unit gets a subsequent transmission to open for response, it can add the appropriate time factor to its clock of response time and give a correct time value from which the response period opened.

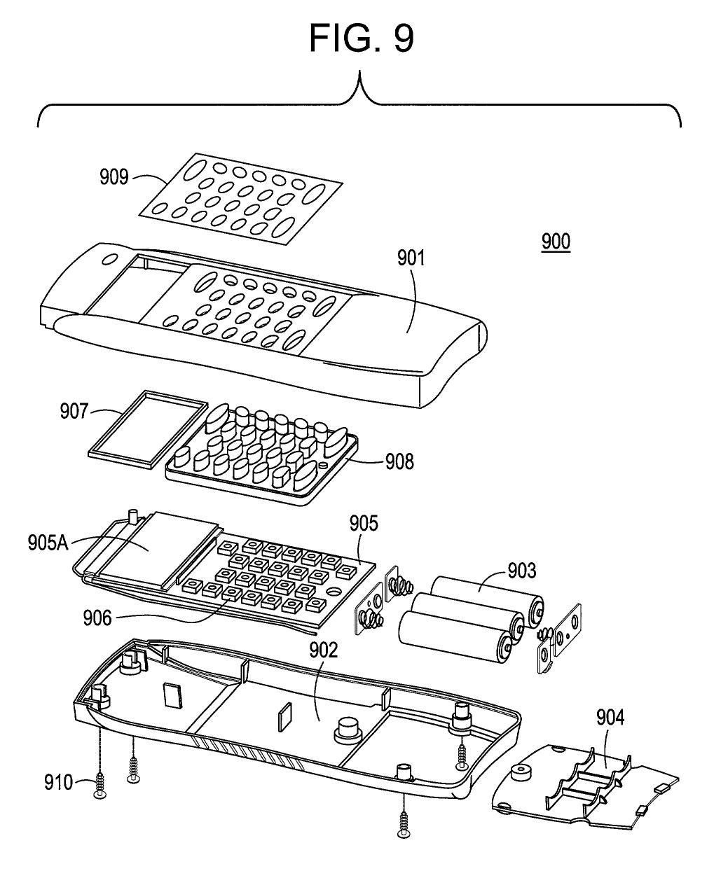

It should be noted that the interval count number sent with each command will also resolve an ambiguity of the portion of the slot sequence. Normally, up to 256 remote response units will be assigned to individual time slots in a single channel. The 256 timeslots may be divided into four groups of 64, so only as many groups as are needed for the number of remote response units registered. If a particular remote response unit receives a start of request command later than the others, and had the no indication of the portion of the slot sequence for which the base transceiver is synchronized, the remote response unit could respond at the wrong time slot and have a collision with responses in other slots, resulting in the loss of data. The low two bits of an 8-bit interval count signal can be used to indicate the timeslot group. The high six bits are a sequential number of groups sent since the start of the request. This transmission will avoid any possible short-term loss of communications between a remote response unit and the transceiver. The present invention is described in terms of a remote response unit, which in one exemplary embodiment is a portable unit and, in a more preferred embodiment, is a hand-held unit as illustrated in FIG. 9. The unit 900 has a front body portion 901 and a back body portion 902 that are mated and joined by screws 910, and is powered by batteries 903 that are accessible through a removable panel 904 in the back body portion. The internal cavity between the top and bottom portions is filled with an electronic board 905 containing the content of FIG. 2, and having a LCD display 905A and key pad switches 906. A lens 907 covers the display and a resilient keypad 908 covers the switches and are operable by a participant. The top portion 901 also receives a face plate, that has appropriate numbers, letters or phrases applied.

The keypad may have the conventional matrix of alpha-numeric keys and/or specialized keys that are programmed individually or in combination (typically 2 at a time) to provide data or command input signals, in a manner known in the art. There also may be special buttons, such as a “Call” button that sends a signal from the remote unit to the central control unit, identifying a request for acknowledgment, like raising one's hand in a classroom. The “Flag” button may be used to determine attendance, so that upon request and following actuation at the remote response units, the central control unit can determine the percentage of connected units that are participating (e.g., back from a break). Any number of other control buttons, such as a special “log in” button, may be incorporated into the remote response unit to satisfy particular needs of an audience response facilitator.

While the present invention has been described in terms of one or more preferred or exemplary embodiments, it is not limited thereto, and the invention is to be defined by the accompanying claims, as interpreted in accordance with applicable law.

We claim:

1. A wireless audience response system comprising:
a plurality of remote response units, each said response units comprising a first transmitter, a first receiver and a first processor coupled to said first transmitter and said first receiver and having a selectable input, said input being operable by a user to instruct said first processor to provide a response output, comprising at least one of a plurality of outputs, to said first transmitter;
a central control unit comprising a second transmitter, a second receiver and a second processor operatively coupled to said second transmitter and said second receiver, said second processor being operative to:
control said second transmitter to selectively transmit a command signal, comprising at least one of a plurality of command signals, to said plurality of remote response units, and
dynamically assign a respective one of a plurality of time slots to a respective one of said remote response units;
wherein the first transmitter at each of said remote response units is in communication with the second receiver at the central control unit over an assigned channel, said assigned channel being operative to carry information input by audience members and transmitted by a plurality of said remote response units in the respective dynamically assigned time slots to said central unit.

2. The wireless audience response system of claim 1, wherein the first receiver at each of said remote response units is in communication with the second transmitter on said assigned channel, and
wherein said second processor is operative to make a time slot assignment of a respective time slot to each of said plurality of remote response units and to control the transmission by said second transmitter to the first receivers at said remote response units of a time slot assignment signal providing notification of said respective time slot assignment.

3. The wireless audience response system of claim 2, wherein said second transmitter is operative to periodically transmit a voting command signal to said plurality of remote response units on said assigned channel during a voting period, and
wherein each of said remote response units is operative to receive said time slot assignment signal and to store said respective time slot assignment, said respective time slot assignment being established relative to a receipt by the first receiver at a remote response unit of a predetermined one of said voting command signals by said remote response unit.

4. The wireless audience response system of claim 3 wherein each of said remote response units is operative to transmit to said central control unit the information input by the audience member during said voting period, said transmission being in its respective assigned time slot.

5. The wireless audience response system of claim 4, wherein said second receiver at said central control unit is operative to receive an information input by the audience member and transmitted by the first transmitter at each said remote response unit within a respective time slot.

6. The wireless audience response system of claim 5, wherein said central control unit is operative to process said information transmitted from each of said remote response units, said processing including generating an analytical output based on said respective response outputs from a plurality of said remote response units.

7. The wireless audience response system of claim 2, wherein said time slot assignment comprises an assignment of one of a plurality of channels and a time slot on the assigned one channel.

8. The wireless audience response system of claim 1, wherein each said remote response unit is identified by a respective unique code, said unique code being provided to said central control unit by a transmission by the first transmitter of said remote response unit.

9. The wireless audience response system of claim 1, wherein said central control unit is operative to periodically generate a command signal, said command signal being receivable by a plurality of remote response units and used as a basis for the timing of a respective transmission of information that has been input by an audience member to said remote response unit.

10. The wireless audience response system of claim 9 wherein at least one of said remote response units comprises a timer, operative in response to a receipt of said command signal by said remote response unit, to control the timing of the transmission by said remote response unit in a respective assigned time slot of information input by an audience member.

11. The wireless audience response system of claim 1 wherein said second transmitter comprises a plurality of transmitting devices, each of said transmitting devices providing at least one respective channel and a plurality of time slots within said at least one channel, and being selectable for communication with particular remote response units.

12. The wireless audience response system of claim 1, wherein at least one of said remote response units is operative to generate and transmit to said central control unit a registration request, and said central control unit is operative to respond to said registration request with an acknowledgment including a slot assignment and a channel assignment for said at least one remote response unit.

13. The wireless audience response system of claim 1 wherein at least one of said plurality of command signals comprises a signal identifying at least one of a single key mode response and a multi-key mode response, said command being operative to limit the operation of the remote response unit to providing the identified response.

14. The wireless audience response system of claim 1 wherein said second processor comprises a plurality of processors, one of said processors being operative by an operator to control the functions of another processor in the conduct of a registration and voting process by said another processor.

15. The wireless audience response system of claim 1, wherein said central control unit is operative to store a correlation among a user log-in ID, a unique ID of each remote response unit and the respective assigned timeslot and channel of said remote response unit.

16. The wireless audience response system of claim 1 wherein said central control unit is operative to control an automatic registration of said plurality of remote response units, said automatic registration comprising a process of newly assigning a channel and a timeslot for each remote response unit.

17. The wireless audience response system of claim 16, wherein during said automatic registration, said central control unit is operative to issue a registration command to a plurality of said remote response units, said plurality of remote response units are operative to issue a registration request to said central control unit a pseudo random delay period after receiving said registration command, and said central control unit is operative to receive the registration request issued from each said remote response units and assign a channel and a timeslot to each said remote response unit.

18. The wireless audience response system of claim 17, wherein each of said remote response units is operative to determine the pseudo random delay by use of the low byte of a unique serial number of said remote response unit.

19. The wireless response system of claim 1 wherein said central control unit is operative to control a manual registration of at least one of said plurality of remote response units said manual registration comprising a process of newly assigning a channel and a timeslot for at least one unregistered remote response unit.

20. The wireless audience response system of claim 19, wherein said central control unit is operative to issue a manual registration command to said plurality of remote response units, selected ones of said plurality of remote response units are operative to issue a registration request to said central control unit in response to operation of a manual registration key after receiving said registration command, and said central control unit is operative to receive the registration request issued from said at least one remote response unit and assign a channel and a timeslot to each said remote response unit.

21. The wireless audience response system of claim 1, wherein said central control unit is operative to transmit an acknowledgment of receipt of information received from a remote response unit, said acknowledgment transmission being delayed by at least one slot time.

22. The wireless audience response system of claim 1, wherein said second transmitter is operative to transmit to each said remote response units an interval signal with a voting command, said interval signal identifying a time between the start of a response period and the time of transmission of said voting command.

23. The wireless audience response system of claim 22, wherein each said remote response units comprises a time marker generator for generating a time marker signal identifying a time between the receipt by said remote response unit of a voting signal from said central control unit and a time a response is entered to said remote response unit by a user.

24. The wireless audience response system of claim 23, wherein each said remote response units further comprises means for generating a response time signal based upon said interval signal and said time marker signal, said response time signal identifying an elapsed time relative to the start of a voting period.

25. A central control unit comprising a transmitter, a receiver and at least one processor and being operative in a wireless audience response system having a plurality of remote response units to be in communication with each of said remote response units over an assigned channel, said assigned channel being operative to carry information transmitted by each of said plurality of remote response units in a respective one of a plurality of dynamically assigned time slots, said central control unit being operative to:
(a) transmit command signals to said plurality of remote response units on the assigned channel and to receive reply signals from at least one of said remote response units on the assigned channel;
(b) register at least one of a plurality of said remote response units and dynamically assign one time slot in said assigned channel to a respective one of said remote response units;
(c) transmit to said at least one remote response unit information identifying said assigned time slot and said assigned channel;
(d) receive a response from each of said plurality of remote response units in respective time slots on said assigned channel; and
(e) correlate and store said response from each of said plurality of remote response units with a unique identifier for each said remote response unit.

26. The central control unit of claim 25 wherein said processor is operative to assign a respective time slot to a respective remote response unit and to control notification of said remote response unit of a time slot assignment.

27. The central control unit of claim 25, wherein said processor is operative to receive a unique identifier transmitted from each of said remote units and to store a correlation of said unique identifier and a respective time slot and channel assignment.

28. The central control unit of claim 25, wherein said processor is operative to receive information transmitted from each said remote response unit within a respective time slot.

29. The central control unit of claim 25, wherein said processor is operative to control transmission of a plurality of commands to said remote response units, said commands including at least one command for use by said remote response units to provide timing synchronization.

30. The central control unit of claim 25, wherein said processor is operative to implement an automatic registration of said remote response units, said automatic registration comprising a dynamic assignment of a respective time slot within a voting frame to each of said remote response units.

31. The central control unit of claim 25, wherein said receiver and said at least one processor are operative to receive transmissions of data from a plurality of remote response units in assigned time slots to detect said data and to store said data.

32. The central control unit of claim 25, wherein said transmitter and said at least one processor are operative to generate a registration command and transmit said command to at least one remote response unit.

33. The central control unit of claim 32, wherein said receiver and said at least one processor are operative to receive a request for registration from at least one of said remote units and acknowledge said request.

34. The central control unit of claim 25 wherein said at least one processor is operative to limit the number of remote response units that may be registered for said transceiver unit.

35. The central control unit of claim 25, wherein said at least one processor is operative to delay an acknowledgment of receipt of a response from a remote response unit by at least one slot time.

36. The central control unit of claim 25, wherein said command signals comprise a voting command and said transmitter and said at least one processor are operative to generate and transmit an interval signal with each voting command, said interval signal identifying a time between the start of a response period and the time of transmission of each said voting command.

37. The central control unit of claim 36, wherein said receiver and said at least one processor are operative to receive a response time signal sent from a remote response unit, said response time signal being based on said interval signal and identifying a time relative to the start of a response period.

38. A method of operating a wireless audience response system having a plurality of remote response units, each of said response units comprising a first transmitter, a first receiver and a first processor coupled to said first transmitter and said first receiver and having a selectable user input, said user input being operable by a user to command said first processor to provide one of a plurality of selectable outputs to said first transmitter, and a central control unit comprising a second transmitter, a second receiver and a second processor coupled to said second transmitter and said second receiver, said second processor being operative control said second transmitter to output command signals, including voting command signals, comprising:
transmitting said command signals by said second transmitter over an assigned channel;
receiving said command signals at said plurality of said remote response units;
in response to receipt of at least one of said command signals, delaying at each of said plurality of remote response units the transmission of a respective selected output to said second receiver in a respective assigned time slot of a response frame over said assigned channel; and
receiving and storing at said central control unit said respective selected outputs transmitted from said plurality of remote response units in respective assigned time slots.

39. The method of operating a wireless audience response system of claim 38, wherein said delayed transmission step further comprises delaying the transmission of said respective selected output a predetermined amount of time following receipt of a received command.

40. The method of operating a wireless audience response system of claim 38, further comprising:
processing at said central control unit selected outputs from a plurality of remote response units to generate a group response, and
outputting said group response.

41. The method of operating a wireless audience response system of claim 40, further comprising:
displaying said group response.

42. The method of operating a wireless audience response system of claim 38 wherein each said remote response unit is operative to transmit in said respective assigned time slot to said central control unit said at least one of a plurality of selectable outputs.

43. The method of operating a wireless audience response system of claim 42, further comprising receiving a transmission of said at least one of a plurality of selectable outputs transmitted from each said remote response unit within a respective time slot.

44. The method of operating a wireless audience response system of claim 43, further comprising processing said at least one of a plurality of selectable outputs from each said remote response unit, said processing comprising generating an output based on said at least one of a plurality of outputs from a plurality of said remote response units.

45. The method of operating a wireless audience response system of claim 38 further comprising assigning a time slot within a response frame, that is defined by a transmitted command, on said assigned channel as said respective time slot.

46. The method of operating a wireless audience response system of claim 45, wherein each said remote response unit is identified by a unique code, further comprising transmitting said unique code by said remote unit to said central control unit with said one of a plurality of selectable outputs.

47. The method of operating a wireless audience response system of claim 46 further comprising registering at said central control unit said transmitted unique code and said assigned time slot for each of a plurality of remote response units.

48. The method of operating a wireless audience response system of claim 38 wherein at said at least one remote response unit, in response to a receipt of a command signal, controlling the timing of the transmission of output information in a respective assigned time slot.

49. The method of operating a wireless audience response system of claim 38 further comprising
issuing a command to a plurality of remote response units to request registration and in response thereto transmitting from a plurality of remote response units a registration request to said central unit, said transmitting step being subject to a variable delay unique to said stations, wherein said delay is predetermined or based on a pseudo random delay factor.

50. The method of operating a wireless audience response system of claim 38 further comprising transmitting an acknowledgment from said central control unit of a receipt of a transmission by a remote response unit, wherein said transmitting step further comprises delaying for a given remote unit by at least one time slot.

51. The method of operating a wireless audience response system of claim 38 further comprising storing registration information, comprising at least a remote unit unique ID an assigned time slot and an assigned channel, from a first audience response session in said central control unit for use in a subsequent audience response session.

52. The method of operating a wireless audience response system of claim 38 further comprising accumulating a time marker in each of said remote response units from the time a voting command is received until a response is sent and sending a value representing said time marker with the response to said voting command.

53. The method of operating a wireless audience response system of claim 38, further comprising transmitting from said central control unit an interval signal with each command signal that is a voting command, said interval signal identifying a time between the start of a response period and the time of transmission of said voting command.

54. The method of operating a wireless audience response system of claim 53, further comprising receiving at said central control unit a response time signal sent from a remote response unit, said response time signal being based on said interval signal and identifying a time relative to the start of a response period.

55. A remote response unit, operative in a wireless audience response system having a plurality of such remote response units in communication with a central control unit over an assigned channel, the assigned channel being operative to carry information transmitted by each of said remote response units in a respective one of a plurality of dynamically assigned time slots within a response frame, said remote response comprising a transmitter, a receiver, a user input and a processor, said unit being operative to:
(a) respond to a command for registration from said central control unit by transmitting a unique ID signal to the central control unit;
(b) receive an assignment by the central control unit of at least one assigned time slot in said assigned channel; and
(c) transmit information to the central control unit within the assigned time slot.

56. The remote response unit of claim 55 wherein said processor is operative to enable storing of the assignment of a respective time slot to said remote response unit by said central control unit.

57. The remote response unit of claim 55, wherein said processor is further operative to enable said transmitter to send a unique identifier from said remote unit to said central control unit.

58. The response unit of claim 55, wherein said processor is operative to enable said transmitter to transmit information, including data entered by said user input within a respective time slot, said transmitted information comprising at least a unique identifier for said remote unit and said data.

59. The remote response unit of claim 55, wherein said receiver is operative to receive a command signal and to receive an acknowledgment signal on said assigned channel, and said processor is operative to respond to at least said command signal.

60. The remote response unit of claim 59, wherein said processor is responsive to a registration command signal and is operative to enable one of manual or automatic registration of said remote unit.

61 The remote response unit of claim 59, wherein said processor is responsive to a voting command signal and is operative to control the timing of the transmission of user input information in a respective assigned time slot.

62. The remote response unit of claim 55 wherein said remote unit is a hand-held unit.

63. The remote response unit of claim 55, said processor being operative to store an interval signal transmitted with a voting command, said interval signal identifying a time between the start of a response period and the time of transmission of said voting command.

64. The remote response unit of claim 63, further comprising a time marker means for accumulating time between the receipt of a start signal and the time a response is entered into said user input.

65. The remote response unit of claim 64, said processor being operative to generate a time marker signal for transmission to said central control unit, said time marker signal identifying a time relative to the start of a response period.
